(19) United States
(12) Patent Application Publication
(10) Pub. No.: US 2024/0378597 A1
(43) Pub. Date: Nov. 14, 2024

(54) TOKEN-BASED USER ACTIVITY STORAGE AND COMPILATION

(71) Applicant: PAYPAL, INC., San Jose, CA (US)

(72) Inventor: Pankaj Sarin, Fremont, CA (US)

(21) Appl. No.: 18/316,479

(22) Filed: May 12, 2023

(51) Int. Cl. G06Q 20/38

(52) U.S. Cl. CPC G06Q 20/3825; G06Q 20/389

(57) ABSTRACT

A method for storing data respective of a time series of electronic transactions respective of a user includes receiving a plurality of indications of data for a plurality of electronic transactions associated with a user, generating a plurality of tokens by generating, for each of the indications, a respective token, each token encoding a respective pointer to a storage location of the respective data, receiving a request for a time series of electronic transactions associated with the user, in response to the request, generating a time series of the plurality of electronic transactions by decoding the plurality of tokens and retrieving the plurality of data according to the pointers.

### TECHNICAL FIELD

The instant disclosure relates to storing and compiling records of user activity based on tokens, including on-demand compilation of a user activity based on the compilation and decoding of tokens.

### BACKGROUND

Data respective of user transactions is generally tracked and stored. For example, data indicative of the parties included in a transaction, the property, services, files, etc., exchanged in the transaction, time, date, and other bibliographic location respective of the transaction, and other data is or can be stored. Accordingly, such information can later be recalled when a user or system needs to know the details of a transaction. Compiling a set of related transactions generally requires searching each stored record individually for matching information, such as the same user, same account, same property, etc.

### BRIEF DESCRIPTION OF THE DRAWINGS

FIG. 1 is a block diagram view of an example system for tracking and compiling records of user activity with tokens.

FIG. 2 is a diagrammatic view of a portion of the system of FIG. 1.

FIG. 3 is a flow chart illustrating an example method of tracking and compiling records of user activity with tokens and using one or more of the tokens to initiate a transaction.

FIG. 4 is a sequence diagram illustrating and example of tracking and storage of user activity based on tokens.

FIG. 5 is a sequence diagram illustrating an example of compiling user activity based on stored tokens.

FIG. 6 is a block diagram view of an example computing environment.

### DETAILED DESCRIPTION

Known transaction data storage systems do not enable rapid compilation of related transactions. Searching individual records in a database for matching information is relatively time-consuming, and thus impractical when substantially real-time determination of related transactions is desired. One particular use case is when a time series of transactions for a particular user, particular account, or particular property is desired to respond to a service request regarding that user, account, or property in a live support scenario. In such a scenario, an ability to rapidly understand which related past transactions exist is a technical challenge.

The instant disclosure includes a solution for the storage of transaction data to enable quick later compilation of related transactions, including but not limited to a time series of related transactions. As will be described herein, tokens encoding pointers to the underlying storage of transaction data, and also including pointers to tokens of related transactions, can be created and stored separately from the transaction data. As a result, sets of related transactions are substantially pre-assembled in a lightweight form, and a series of related transactions can be assembled substantially in real-time when needed, such as when responding to a user request in a live support scenario.

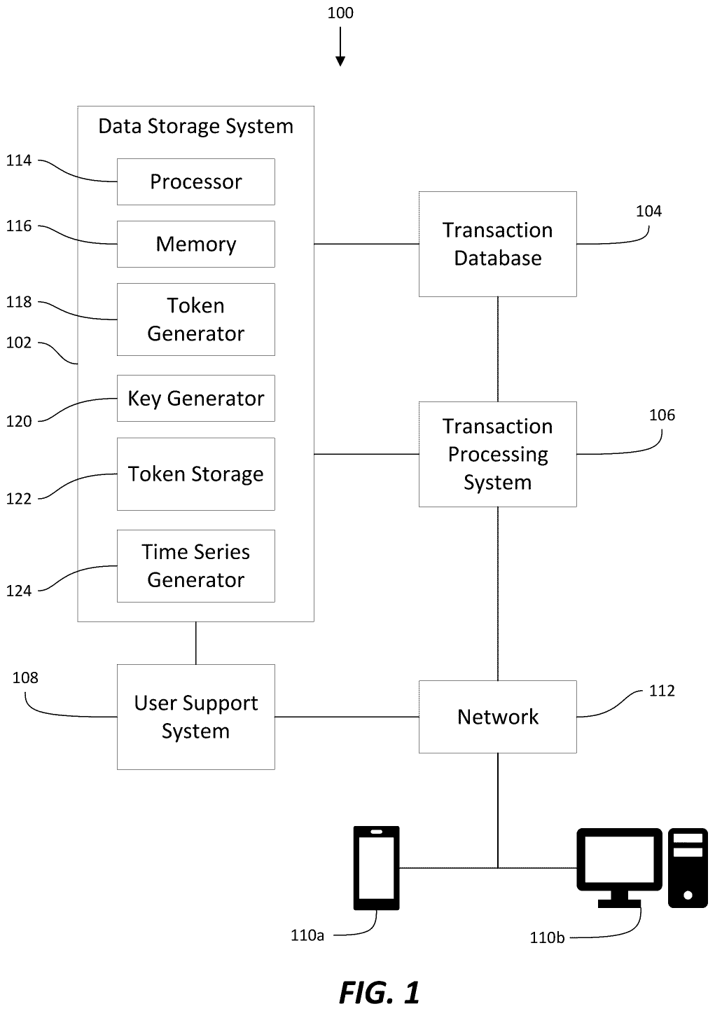

Referring to the drawings, wherein like reference numerals refer to the same or similar features in the various views, FIG. 1 is a block diagram view of an example system 100 for tracking, storing, and compiling user activity according to tokens. The system 100 may include a data storage system 102, a transaction database 104, a transaction processing system 106, a user support system 108, and one or more user computing devices 110a, 110b (which may be referred to individually as a user computing device 110 or collectively as the user computing devices 110). The user computing devices 110 may be in electronic communication with one another, with the transaction processing system 106, and/or with the user support system 108 through a network 112.

Users may initiate transaction, review transactions, complete transactions, etc. on user computing devices 110 through the transaction processing system 106. Accordingly, the transaction processing system 106 may receive, from a user computing devices 110, instructions to initiate a transaction, an instruction to accept or complete a transaction, an instruction to review one or more transactions, etc., and may respond by performing or facilitating the requested user action. Such transactions may include, for example, a computing transaction such as a file creation, a revision to a file, an electronic communication, a financial transaction (or component thereof), a real-estate transaction (or component thereof), a service request, or any other electronic transaction. Additionally or alternatively, an electronic transaction according to the present disclosure may be or may include an event associated with a user, such as a user navigation to a webpage, a user search request, etc. Still further, such an electronic event may be or may include an interaction between a user and the electronic transaction system 102, an interaction between the electronic transaction system 102 and a third-party system (e.g., a third party payment system, a third party file system, a third party security system, etc.), or a processing operation by the electronic transaction system 102 (e.g., processing a transaction instructed by a user device 110 or which relates to a user of a user device 110).

The transaction processing system 106 may be in electronic communication with one or more external systems, such as one or more transaction card systems, one or more external financial institutions, one or more file storage systems, one or more electronic messaging systems, and the like. Accordingly, the transaction processing system 106 may have access to data respective of user transactions that occur, in whole or in part, outside of the transaction processing system 106, as well as user transactions that occur entirely within the transaction processing system 106.

The transaction processing system 106 may be associated with a particular electronic user interface and/or platform through which a user performs electronic transactions. The electronic user interface may be embodied in a website, mobile application, etc. According, the transaction processing system 106 may be associated with or wholly or partially embodied in one or more servers, which server(s) may host the interface, and through which the user computing devices 110 may access the user interface.

The transaction database 104 may store records of one or more transactions in which the transaction processing system 106 is involved and/or one or more other transactions associated with a user of a user computing device 110. The transaction processing system 108 may cause records of transactions to be stored in, or retrieved from, the transaction database 104.

The user support system 108 may receive and service support requests from the user computing devices 110. For example, such user support requests may include a request for information about a transaction (e.g., a transaction involving the transaction processing system 106), a request for assistance with a transaction, and the like. The user support system 108 may include or may be associated with an automated response system that detects a user intent based on a user request such as entered user text, words spoken by the user, etc. and provides an automated response. In some embodiments, the user support system may determine a time series of prior user transactions in order to interpret the user's request, as described herein. That time series may be generally referred to as a user “journey” in industry.

The data storage system 102 may be configured to create and store tokens representative of user transactions and to create a compilation of activity of a given user when requested. The data storage system 102 may receive data from and/or output data to the transaction database 104, the transaction processing system 106, and the user support system 108, in embodiments.

The data storage system 102 may include a processor 114 and non-transitory, computer readable memory 116 that, when executed by the processor 114, cause the data storage system 102 to perform one or more of the steps, processes, methods, operations, etc. described herein with respect to the data storage system 102. The data storage system 102 may include one or more functional modules embodied in the memory 116. The functional modules may include a token generator 118, a key generator 120, and a time series generator 124. The data storage system 102 may further include a token storage 122, which may include one or more data memories (e.g., databases).

The token generator 118 may be configured to generate tokens respective of user transactions. Each such token may encode a pointer to a storage location of the data respective of the transaction, a pointer to an associated transaction, and/or other information.

The key generator 120 may generate keys for decoding the tokens generated by the token generator 118. In some embodiments, the key generator may generate one or more keys for each token such as, for example, a public key associated with the token and a private key associated with the token. The key generator may further cause one of more keys associated with the token to be distributed to, e.g., the user whose transaction is encoded in the corresponding token and/or to one or more other destinations of the underlying transaction information.

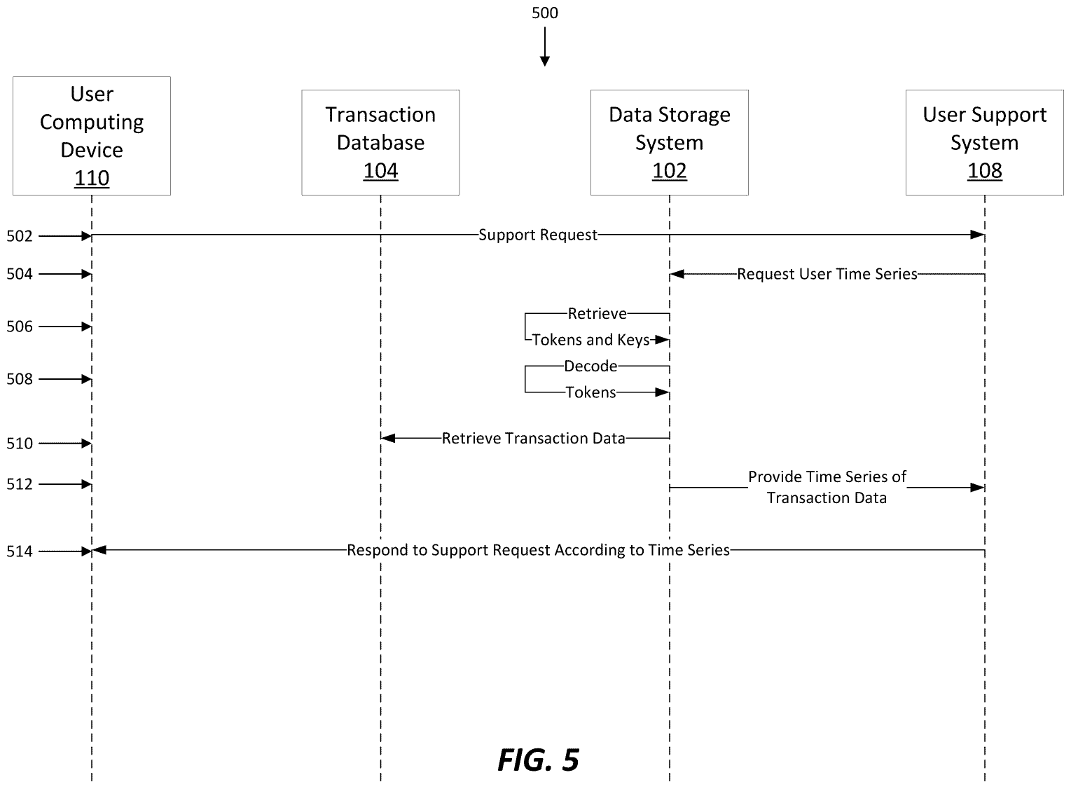

The time series generator 124 may generate a time series of a plurality of transactions by decoding tokens respective of those transactions. For example, in some embodiments, a request for a time series may be received by the data storage system 102 from the user support system 108, from a user via a user computing device 110, and/or from the transaction processing system 106. An example process for decoding tokens to assemble a time series will be described herein with respect to FIG. 5.

In operation, the transaction processing system 106 may receive one or more user transactions (or instructions to perform those transactions), may cause data respective of each transaction to be stored in the transaction database 104, and may cause a token respective of each transaction to be generated and stored in the data storage system 102. Each token stored in the data storage system 102 may encode a pointer to the underlying data in the transaction database 104, rather than a duplicate copy of the transaction data itself.

As noted above, the tokens stored in the token storage 122 may be used to assemble a time series of transactions (e.g., of related transactions). The tokens may also be used, for example, to execute additional transactions. For example, a token that encodes a pointer to transaction data may be used as a payment token for a further transaction. The payment information for that further transaction may ultimately be based on the payment used for the transaction to which the token points, in some embodiments.

In another example, the token storage 122 may enrich a stored token with insights based on the time series of which the token is a part. For example, a token may be enriched with data respective of a user sentiment. Too many failed attempts to make a payment with card followed by a successful payment using the same card may lead to a negative sentiment, for example. An enriched token may then be processed as part of a payment transaction, and the enrichment information may be used to alter or supplement the transactions. For example, a user with a sentiment score above a threshold may be offered an incentive for a particular transaction, such as a transaction fee discount or reward for completing the transaction. In addition, the tokens referencing the user activities may be stored in connection with individual TTL (Time to Live). As a result, the storage w.r.t tokens can further be optimized. The TTL values can be determined by a risk management system according to the enriched data, such as user sentiment or user trustworthiness, for example, and provided to the data storage system 102. The data storage system 102 may automatically delete a token when its TTL has expired.

In some embodiments, a set of related tokens may be stored in a dedicated data structure (e.g., array). The data structure may include metadata that identifies the basis on which the tokens are related (e.g., an identifier of the user common to the transactions to which the tokens relate, an account common to the transactions, etc.). Accordingly, in some embodiments, the token storage 122 may include a plurality of arrays or other data structures, with a respective data structure for each user, each account, etc.

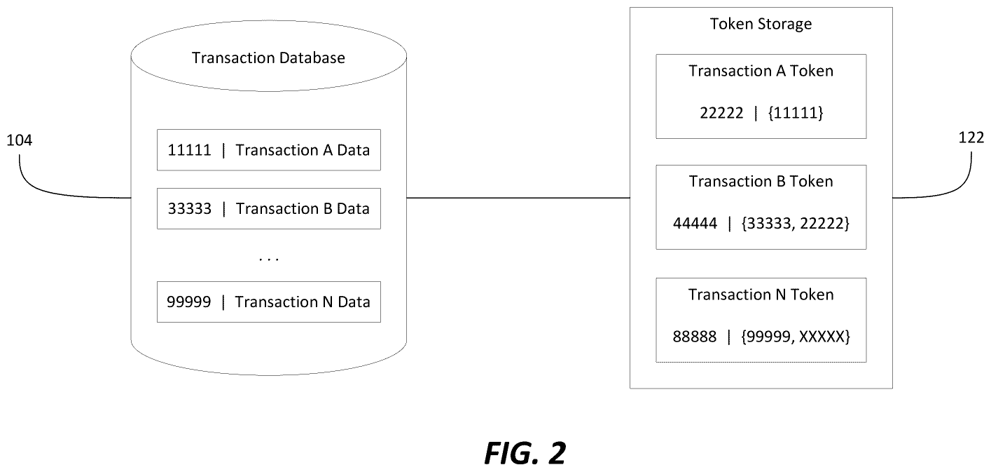

FIG. 2 is a diagrammatic view of the transaction database 104 and the token storage 122, illustrating examples of tokens having pointers to data stored in the transaction database 104 and pointers to other tokens. In the example of FIG. 2, the transaction database 104 stores data respective of a plurality of transactions stored in respective memory locations. Specifically, the transaction database 104 stores Transaction A Data at memory location 11111 Transaction B Data at memory location 33333, and Transaction N Data at memory location 99999. Transactions A, B, and N (and any intervening transactions between B and N) are related. For example, Transactions A, B, and N may be transactions involving the same user, involving the same account, involving the same asset, etc.

The token storage 122 stores tokens of the same set of transactions in its own respective memory locations. Specifically, the token storage 122 stores a Transaction A Token at memory location 22222, a Transaction B Token at memory location 44444, and a Transaction N Token at memory location 88888. The Transaction A Token includes a pointer to memory location 11111 (i.e., the storage location of the underlying data respective of transaction A). The Transaction B Token includes a pointer to memory location 33333 (i.e., the storage location of the underlying data respective of transaction B). The Transaction N Token includes a pointer to memory location 99999 (i.e., the storage location of the underlying data respective of transaction N). None of the tokens include the underlying data itself, in the illustrated embodiment.

As noted above, transactions A, B, and N are related. Accordingly, the tokens respective of transactions B and N also include pointers to tokens respective of related transactions. Specifically, the Transaction B Token includes a pointer to the memory location of the Transaction A Token, 22222. Similarly, the Transaction N Token also includes a pointer to the memory location of an intervening token, XXXXX. Accordingly, the token storage may store a plurality of tokens, each of which includes a pointer to the storage location of data respective of the associated transaction. Some of the tokens may additionally include a pointer to a token respective of a related transaction.

Each token may be embodied as an encrypted representation of the pointers included in the token. Accordingly, each token may encode the one or more pointers included in the token.

It should be understood that the memory location addresses included in FIG. 2 are illustrative in nature only and do not represent actual memory locations. It will be appreciated that actual memory addresses encoded in or represented by pointers in the tokens may take any appropriate form for the type of data storage used.

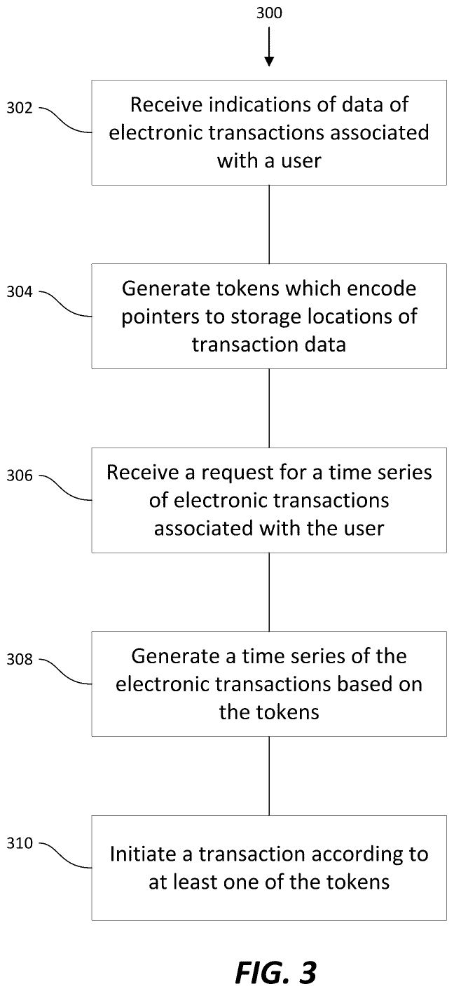

FIG. 3 is a flow chart illustrating an example method 300 of tracking and compiling records of user activity with tokens and using one or more of the tokens to initiate a transaction. The method 300, or one or more aspects of method 300, may be performed by the data storage system 102, in some embodiments.

The method 300 may include, at block 302, receiving one or more indications of data of electronic transactions associated with a user. For example, a user may have instructed or been involved in a plurality of transactions. For each of those transactions, block 302 may include receiving an indication that the transaction has occurred and a storage location of the data associated with that transaction. In some embodiments, block 302 does not include receiving the underlying data itself of the transaction.

In an embodiment, block 302 may include the data storage system 102 receiving an indication of a transaction from the transaction processing system 106 and/or the transaction database 104 in parallel with, or after, the transaction database 104 storing the data respective of the transaction. The indication may be or may include, for example, an identifier for a user, an account, an item of property, or other basis on which transactions are to be associated with one another, as well as the storage location for the transaction data. Further underlying data of the transaction may or may not be transmitted to the data storage system 102 in such an example.

In an embodiment, block 302 may include receiving a plurality of indications of a plurality of data of a plurality of electronic transactions associated with a single user. The plurality of data may be or may include, for example, electronic records of the underlying data of the transactions.

The method 300 may further include, at block 304, generating tokens which encode pointers to the storage locations of the transaction data. Block 304 may include, for example, generating a respective token for each transaction for which an indication is received at block 302. Generating a token may include, for example, encoding a pointer to a storage location of the underlying data. Generating a token may also include encoding a pointer to a token respective of a transaction for the same entity (e.g., the same user, the same account, the same item of property, etc.). Accordingly, block 304 may include searching stored tokens for other tokens related to the same entity (e.g., for the most recent such token), and including a pointer to that stored token in the created token. As a result of including a pointer to a most recent token for the same user in the token for a given transaction, block 304 may generally include creating a linked sequence of tokens respective of a given subject (e.g., a given user), with each token pointing back to a previous token as well as to a specification transaction.

Block 304 may further include generating and/or receiving one or more keys that may be used to encode and/or decode the created token. For example, block 304 may include receiving the one or more keys from a third-party token service provider (TSP). In another example, block 304 may include the data storage system 102 generating the one or more keys. The key(s) may be stored in connection with the associated token in the token storage 122.

In an embodiment, block 304 may include generating, for each of the indications received at block 302, a respective token, with each token encoding a respective pointer to a storage location of the respective data indicated by the received indication. Further, block 304 may include storing a respective key in association with each stored token. Where multiple linked tokens are created and stored, the key of a later token may be required to use the key of an earlier token.

The method 300 may further include, at block 306, receiving a request for a time series of electronic transactions associated with a user. The user may be a user for which a series of transaction indications was received at block 302 and a plurality of tokens was generated at block 304. The request for a time series may be received by the data storage system 102 from the user support system 108 when the user support system 108 receives a request from the relevant user, for example. In another example, the time series request may be received directly from a user. In another example, the time series request may be received from the transaction processing system 106 (e.g., for the transaction processing system to assess a risk associated with the user).

Although block 306 is described above with respect to a single user, a single account, a single item or property, or other type of information may be the basis for a time series request, in embodiments.

The method 300 may further include, at block 308, generating a time series of electronic transactions respective of the user noted in block 306. Block 308 may include generating the time series based on the tokens created at block 304 such as, for example, by decoding a plurality of tokens and retrieving the plurality of data to which pointers in the tokens point. Generating the time series at block 308 may include, in an embodiment, locating the most recent token respective of the user and decoding the token with the stored associated key. Once the most recent token is decoded, a first pointer to a data storage location for an underlying transaction will be obtained, as well as a pointer to a second token. Block 308 may include retrieving the transaction data from the storage location indicated by the pointer. The second token stored at the pointer location may be retrieved and decoded to obtain a second pointer to a data storage location for data respective of a second transaction, and a pointer to a third token. The process may be repeated for as many tokens are stored in the linked sequence for the user, or for a particular predetermined quantity of tokens.

Block 308 may include formatting the generated time series and outputting the generated time series to the source from which the request was received at block 306. For example, block 308 may include outputting information about a series of transactions including, for each transaction, a date and/or time, a type of transaction, one or more entities included in the transaction, a quantity in the transaction (e.g., of property, services, currency, etc.), and/or other information about the transaction. The time series may be formatted in a table or other user-readable format, where it is to be consumed by a user. Alternatively, the time series may be formatted in a CSV or other computer-readable format, where it is to be consumed by a computing system (e.g., the user support system 108).

In some embodiments, block 308 may include retrieving and decoding the tokens in the linked sequence and outputting the obtained pointers to the source of the request. Such an approach may be employed, for example, where the request is received from an entity with access to the transaction database 104.

The method 300 may further include, at block 310, initiating a transaction according to at least one of the tokens generated at block 304. Block 310 may include, for example, retrieving a token respective of a user for use as a payment token in a purchase transaction by the user. For example, block 310 may include retrieving a token which encodes a pointer to data respective of a previous purchase by the same user. As a result, the token may ultimately lead to an encoded, stored form of payment associated with the user.

Block 310 may include, in some embodiments, retrieving a first token associated with the user, decoding the first token, and determining if the transaction pointer encoded in the first token points to data respective of a purchase transaction. If so, the token may be used as the payment token. If, instead, the encoded pointer points to a non-purchase transaction, such that a payment form of the user is not associated with the pointed-to transaction associated with the first token, then block 310 may include retrieving a second token to which another pointer in the first token points. Block 310 may then include decoding the second token and determining if the transaction pointer encoded in the second token points to data respective of a purchase transaction, and the process may continue until transaction information including a form of the user's payment is found. The associated token may then be used as a payment token at block 310.

In another example of block 310, a sequence of transactions associated with a user may be determined based on a plurality of stored tokens associated with the user. Based on the sequence, it may be determined (e.g., the data storage system 102 may determine) that the user enters into a specific transaction on a regular, predictable basis. For example, the transaction may be a recurring payment for a service or subscription. In response to the determination, block 310 may include pre-generating a payment token for the recurring payment, before the payment is requested or instructed. The token may be pre-generated, for example, at a time (e.g., day of week or time of day) when processing resources are more available, to result in overall more efficient processing by an associated computing system. In addition, pre-generating the token may result in a faster payment process at the time the recurring payment is instructed.

The transaction initiated at block 310 may be a payment transaction. The payment transaction may be a different transaction from the plurality of electronic transactions indicated at block 302. Further, the initiated payment transaction may include a payment from the user to a merchant, and the payment transaction may be initiated in response to a request from the user, or in response to a request for payment from the merchant.

Block 310 may be performed by the data storage system 102 in conjunction with the transaction processing system 106, in some embodiments. For example, the transaction processing system 106 may receive a payment instruction from a user computing device 110 and may determine that a payment token is required. Before requesting a new payment token from a dedicated payment token service or generating a payment-specific token, the transaction processing system 106 may request a user token from the data storage system 102, and the data storage system 102 may find and return a user transaction token, to be used as a payment token, as described above. The transaction processing system 106 may then use the retrieved user token as a payment token in the payment transaction instructed by the user.

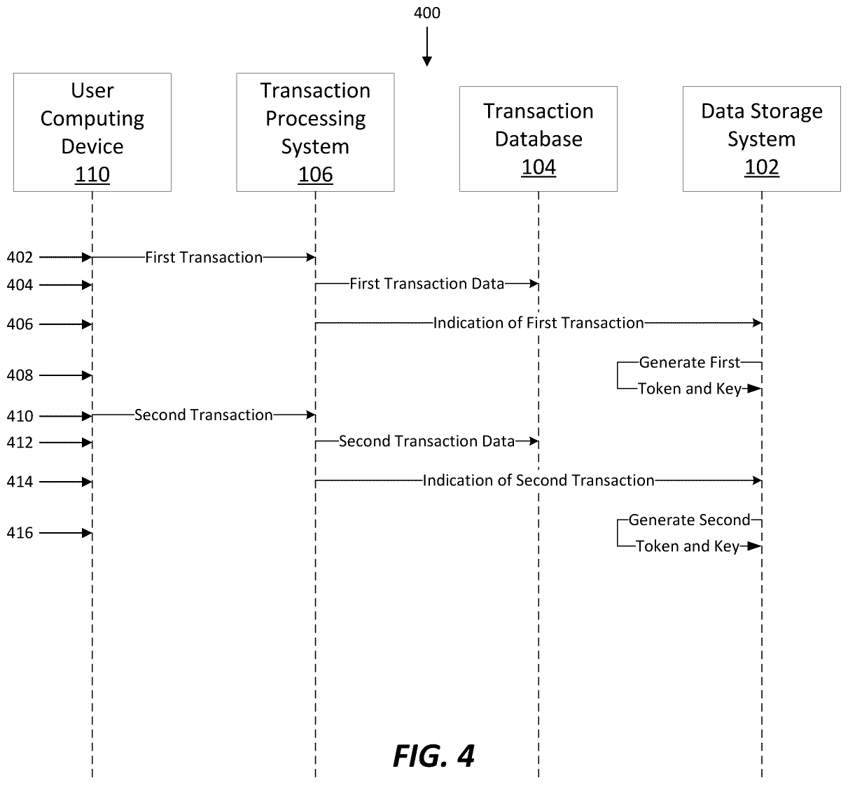

FIG. 4 is a sequence diagram illustrating an example process 400 of generating tokens respective of two transactions. The process 400 may include, at 402, a user computing device 110 transmitting an instruction for a first transaction to the transaction processing system 106. The first transaction may be, for example, a payment transaction, a navigation transaction, a search transaction, a support transaction, a file transfer transaction, or another type of electronic transaction.

The process 400 may further include, at 404, the transaction processing system transmitting first transaction data (i.e., data of the first transaction) to the transaction database 104 for the full data associated with the first transaction to be stored in the transaction database 104. The full transaction data may include, for example, a date and/or time of the transaction, one or more parties to the transaction, a subject of the transaction (e.g., an item of property, service, etc. exchanged in the transaction), a user action in the transaction (e.g., a user search query, a user navigation, etc.), etc. In response to transmitting the transaction data, the transaction processing system 106 may receive a location at which the first transaction data is stored in the transaction database 106.

The process 400 may further include, at 406, the transaction processing system 106 transmitting, and the data storage system 102 receiving, an indication of the first transaction. The indication may be or may include, for example, a basis on which the transaction may be tokenized (e.g., identification information of the user that instructed the first transaction) and a storage location of the full first transaction data.

The process 400 may further include, at 408, the data storage system 102 generating a first token and key in response to the received indication of the first transaction. The token may encode a pointer to the storage location of the first transaction data, and the key may be used to decode the first token.

The process 400 may further include, at 410, the user computing device 110 transmitting an instruction for a second transaction to the transaction processing system 106. The second transaction may be, for example, a payment transaction, a navigation transaction, a search transaction, a support transaction, a file transfer transaction, or another type of electronic transaction.

The process 400 may further include, at 412, the transaction processing system 106 transmitting second transaction data (i.e., data of the second transaction) to the transaction database 104 for the full data associated with the second transaction to be stored in the transaction database 104. The full transaction data may include, for example, a date and/or time of the transaction, one or more parties to the transaction, a subject of the transaction (e.g., an item of property, service, etc. exchanged in the transaction), a user action in the transaction (e.g., a user search query, a user navigation, etc.), etc. In response to transmitting the transaction data, the transaction processing system 106 may receive a location at which the second transaction data is stored in the transaction database 106.

The process 400 may further include, at 414, the transaction processing system 106 transmitting, and the data storage system 102 receiving, an indication of the second transaction. The indication may be or may include, for example, a basis on which the second transaction may be tokenized (e.g., identification information of the user that instructed the second transaction) and a storage location of the full second transaction data.

The process 400 may further include, at 416, the data storage system 102 generating a second token and key in response to the received indication of the second transaction. The second token may encode a pointer to the storage location of the second transaction data, and the key may be used to decode the second token. The second token may also encode a pointer to the first token. Accordingly, 416 may include determining that a prior token for the same user exists (i.e., the first token) and generating a pointer to the storage location of that first token for inclusion in the second token.

FIG. 5 is a sequence diagram illustrating an example of compiling user activity based on stored tokens. The process 500 may include, at 502, a user computing device 110 transmitting, and the user support system 108 receiving, a support request. The support request may be submitted through an automated chat program through an electronic user interface, for example.

The process 500 may further include, at 504, the user support system 108 transmitting, and the data storage system 102 receiving, a request for a user time series, e.g., a request for a time series of the most recent transactions involving the user that submitted the support request at 502. The user support system 108 may transmit the request for the user time series in response to receiving the support request.

The process 500 may further include, at 506, the data storage system 102 retrieving one or more tokens and keys associated with the user in response to the received request for a user time series and, at 508, decoding the retrieved tokens. As described herein, 506 and 508 may happen iteratively, with the data storage system 102 retrieving a token, decoding the token to obtain a pointer to a next token, decoding the next token, and so on.

The process 500 may further include, at 510, the data storage system 102 retrieving transaction data from the transaction database 106 according to the decoded tokens. Specifically, the data storage system may request data from data storage locations identified by the encoded pointers in the decoded tokens. The data may be respective of a plurality of transactions respective of the user. The data storage system 102 may arrange the retrieved data into a time series (e.g., chronologically). In some embodiments, the data storage system 102 may receive a new token in a chain that the data storage system 102 is in the process of decoding to form a time series and may adjust or supplement the time series to include the new token.

The process 500 may further include, at 512, the data storage system 102 transmitting the assembled time series to the user support system 108 in response to the request for the time series at 504. The user support system 108 may then determine a response to the user support request according to the received time series and, at 514, transmit the response to the user computing device. The response at 514 may be or may include offering the user assistance according to the generated time series. Offering the user assistance may include, for example, inquiring about a payment transaction involving the user, transmitting a notification involving an electronic transaction involving the user, or providing a status regarding a transaction involving the user.

The user support system 108 may analyze the user time series to determine an intent of the user's support request, and may use that intent to determine an appropriate response, in some embodiments. For example, the user support system 108 may analyze the user time series, determine that the user has begun a transaction that has not been completed (e.g., the user has navigated to a particular document download web page repeatedly but has not downloaded the document) and, in response to the user's support request, offer to assist with the incomplete transaction, or ask the user if the user intends to complete the transaction. In another example, the user support system 108 may determine that the user is involved in a pending transaction (e.g., the user has initiated a file transfer, but the transferred file has not yet been downloaded by the other party) and, in response, provide a status of the pending transaction to the user. In another example, the user support system 108 may determine that the user regularly enters into a particular transaction (e.g., a recurring file backup) and, in response, offer the user an option to enter into the particular transaction again. In each of these options, the user support system may analyze the time series to determine a frequency, quantity, and/or sequence of one or more types of transactions.

In addition to or instead of a user support system 108, a time series may be transmitted to and utilized by other systems, such as a risk management system for example. A risk management system may examine a time series or one or more enriched tokens respective of a user and may take responsive action with respect to that user, such as by requiring additional actions before processing a transaction on behalf of or involving the user, or in determining whether or not to process such a transaction.

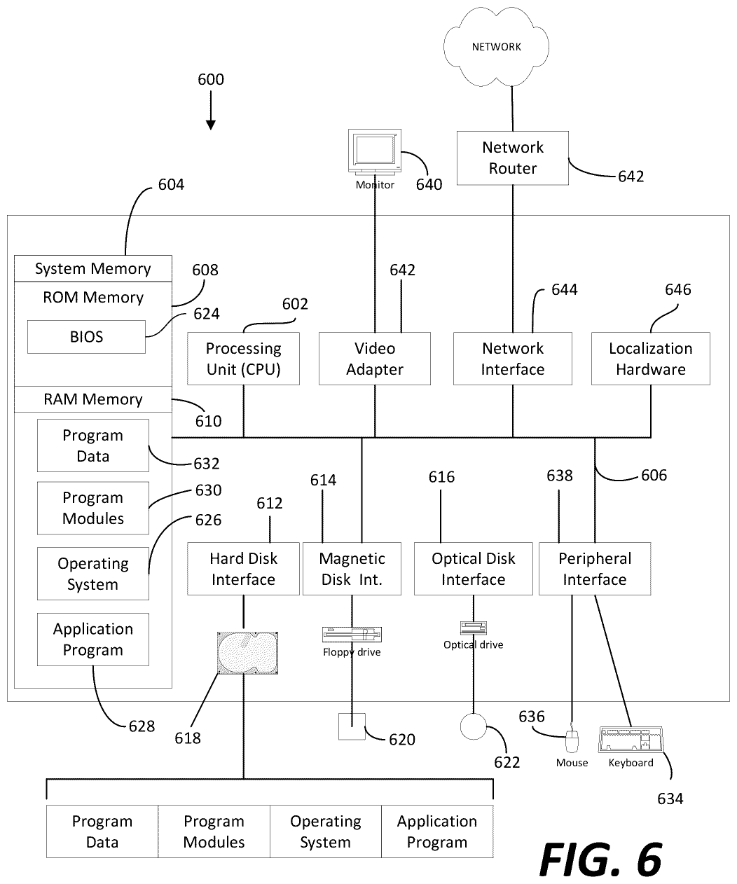

FIG. 6 is a block diagram of an example computing system 600, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628, other program modules 630, and/or program data 632. Still further, computer-executable instructions may be downloaded to the computing environment 600 as needed, for example, via a network connection. The applications programs 628 may include, for example, one or more of the token generator 118, key generator 120, and/or time series generator 124.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 642. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 642, that is responsible for network routing. Communications with the network router 642 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600.

In a first aspect of the present disclosure, a computer-implemented method for storing data respective of a time series of electronic transactions respective of a user is provided. The method includes receiving, by a computing system, a plurality of indications of a plurality of data of a plurality of electronic transactions associated with a user, generating, by the computing system, for each of the indications, a respective token, each token encoding a respective pointer to a storage location of the respective data, receiving, by the computing system, a request for a time series of electronic transactions associated with the user, in response to the request, generating, by the computing system, a time series of the plurality of electronic transactions by decoding the plurality of tokens, and retrieving the plurality of data according to the pointers.

In an embodiment of the first aspect, the plurality of electronic transactions comprise electronic events associated with the user. In a further embodiment of the first aspect, the electronic events comprise one or more of: an interaction between a user and an electronic transaction system, an interaction between the electronic transaction system and a third-party system, or a processing operation by the electronic transaction system.

In an embodiment of the first aspect, the plurality of data comprise electronic records of data of the transaction.

In an embodiment of the first aspect, the plurality of tokens comprises a first token, the first token encoding a first pointer to a storage location of the first data, and a second token, the second token encoding a second pointer to a storage location of the second data and a third pointer to the first token. In a further embodiment of the first aspect, the first token comprises a first key that decodes the first token and the second token comprises a second key that decodes the second token, such the first key enables use of the second key.

In an embodiment of the first aspect, the time series is generated in response to a customer service request submitted by the user to an automated customer service system associated with the computing system, and the computer-implemented method further comprises offering the user assistance, by the automated customer service system, according to the generated time series. In a further embodiment of the first aspect, offering the user assistance, by the automated customer service system, according to the generated time series includes one or more of determining an intent of the customer service request, analyzing the generated time series to identify an incomplete transaction and, in response, offering assistance to the user with the incomplete transaction, or analyzing the time series to identify a pending transaction and, in response, provide a status of the pending transaction.

In a second aspect of the present disclosure, a computer-implemented method for storing data respective of a time series of electronic transactions respective of a user is provided. The method includes receiving, by a computing system, a first indication of first data respective of a first electronic transaction associated with a user, generating, by the computing system, a first token, the first token encoding a first pointer to a storage location of the first data, receiving, by the computing system, a second indication of second data respective of a second electronic transaction associated with the user, and generating a second token, the second token encoding a second pointer to a storage location of the second data and a third pointer to the first token.

In an embodiment of the second aspect, the method further includes generating, by the computing system, a time series comprising the first electronic transaction and the second electronic transaction by decoding the first token and the second token.

In an embodiment of the second aspect, the method further includes receiving, by the computing system, a third indication of third data respective of a third electronic transaction associated with the user, and generating a third token, the third token encoding a fourth pointer to a storage location of the third data and a fifth pointer to the second token.

In an embodiment of the second aspect, the method further includes generating, by the computing system, a time series comprising the first electronic transaction, the second electronic transaction, and the third electronic transaction by decoding the first token, the second token, and the third token.

In a third aspect of the present disclosure, a computer-implemented method for storing data respective of a time series of electronic transactions respective of a user is provided. The method includes receiving, by a computing system, indications of respective data of each of a plurality of electronic transactions associated with a user, generating, by the computing system, a respective token for each of the plurality of electronic transactions, the token encoding a respective pointer to a storage location of the data associated with the electronic transaction, wherein at least one of the respective tokens additionally encodes a pointer to one of the other plurality of tokens, and initiating a payment transaction according to the at least one of the respective tokens.

In an embodiment of the third aspect, the method further includes generating, by the computing system, a time series of the plurality of electronic transactions by decoding the tokens. In a further embodiment of the third aspect, the payment transaction is initiated based on a request for the time series. In a further embodiment of the third aspect, the plurality of electronic transactions comprise a first electronic transaction and a second electronic transaction, and the respective tokens comprise a first token, the first token encoding a first pointer to a storage location of first data associated with the first electronic transaction, and a second token, the second token encoding a second pointer to a storage location of second data associated with the second electronic transaction and a third pointer to the first token. In a further embodiment of the third aspect, the method further includes receiving, by the computing system, a third indication of third data respective of a third electronic transaction associated with the user, and generating a third token, the third token encoding a fourth pointer to a storage location of the third data, and a fifth pointer to the second token.

In an embodiment of the third aspect, the payment transaction is not one of the plurality of electronic transactions.

In an embodiment of the third aspect, the payment transaction comprises a payment from the user to a merchant. In a further embodiment of the third aspect, the payment transaction is initiated in response to a request from the merchant.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method for storing data respective of a time series of electronic transactions respective of a user, the method comprising:
receiving, by a computing system, a plurality of indications of data representing a plurality of electronic transactions associated with a user;
generating, by the computing system, a plurality of tokens by generating, for each of the indications, a respective token, each token encoding a respective pointer to a storage location of the respective data;
receiving, by the computing system, a request for a time series of electronic transactions associated with the user;
in response to the request, generating, by the computing system, a time series of the plurality of electronic transactions by:
decoding the plurality of tokens; and
retrieving the plurality of data according to the pointers.

2. The computer-implemented method of claim 1, wherein the plurality of electronic transactions comprise electronic events associated with the user.

3. The computer-implemented method of claim 2, wherein the electronic events comprise one or more of:
an interaction between a user and an electronic transaction system;
an interaction between the electronic transaction system and a third-party system; or
a processing operation by the electronic transaction system.

4. The computer-implemented method of claim 1, wherein the plurality of data comprise electronic records of data of the transaction.

5. The computer-implemented method of claim 1, wherein the plurality of tokens comprises:
a first token, the first token encoding a first pointer to a storage location of first data; and
a second token, the second token encoding a second pointer to a storage location of the second data and a third pointer to the first token.

6. The computer-implemented method of claim 5, wherein the first token comprises a first key that decodes the first token and the second token comprises a second key that decodes the second token, such that the first key enables use of the second key.

7. The computer-implemented method of claim 1, wherein:
the time series is generated in response to a customer service request submitted by the user to an automated customer service system associated with the computing system; and
the computer-implemented method further comprises offering assistance to the user, by the automated customer service system, according to the generated time series.

8. The computer-implemented method of claim 7, wherein offering the user assistance according to the generated time series comprises one or more of:
determining an intent of the customer service request;
analyzing the generated time series to identify an incomplete transaction and, in response, offering assistance to the user with the incomplete transaction; or
analyzing the time series to identify a pending transaction and, in response, provide a status of the pending transaction.

9. A computer-implemented method for storing data respective of a time series of electronic transactions respective of a user, the method comprising:
receiving, by a computing system, a first indication of first data respective of a first electronic transaction associated with a user;
generating, by the computing system, a first token, the first token encoding a first pointer to a storage location of the first data;
receiving, by the computing system, a second indication of second data respective of a second electronic transaction associated with the user; and
generating a second token, the second token encoding:
a second pointer to a storage location of the second data, and
a third pointer to the first token.

10. The computer-implemented method of claim 9, further comprising:
generating, by the computing system, a time series comprising the first electronic transaction and the second electronic transaction by decoding the first token and the second token.

11. The computer-implemented method of claim 10, further comprising:
receiving, by the computing system, a third indication of third data respective of a third electronic transaction associated with the user; and
generating a third token, the third token encoding:
a fourth pointer to a storage location of the third data, and
a fifth pointer to the second token.

12. The computer-implemented method of claim 11, further comprising:
generating, by the computing system, a time series comprising the first electronic transaction, the second electronic transaction, and the third electronic transaction by decoding the first token, the second token, and the third token.

13. A computer-implemented method for storing data respective of a time series of electronic transactions respective of a user, the method comprising:
receiving, by a computing system, indications of respective data of each of a plurality of electronic transactions associated with a user;
generating, by the computing system, a respective token for each of the plurality of electronic transactions, the token encoding a respective pointer to a storage location of the data associated with the electronic transaction;
wherein at least one of the respective tokens additionally encodes a pointer to one of the other tokens in the plurality of tokens; and
initiating a payment transaction according to the at least one of the respective tokens.

14. The computer-implemented method of claim 13, further comprising:
generating, by the computing system, a time series of the plurality of electronic transactions by decoding the tokens.

15. The computer-implemented method of claim 14, wherein the payment transaction is initiated based on a request for the time series.

16. The computer-implemented method of claim 14, wherein:
the plurality of electronic transactions comprise a first electronic transaction and a second electronic transaction, and
the respective tokens comprise:
a first token, the first token encoding a first pointer to a storage location of first data associated with the first electronic transaction; and
a second token, the second token encoding:
a second pointer to a storage location of second data associated with the second electronic transaction, and
a third pointer to the first token.

17. The computer-implemented method of claim 16, further comprising:
receiving, by the computing system, a third indication of third data respective of a third electronic transaction associated with the user; and
generating a third token, the third token encoding:
a fourth pointer to a storage location of the third data, and
a fifth pointer to the second token.

18. The computer-implemented method of claim 13, wherein the payment transaction is not one of the plurality of electronic transactions.

19. The computer-implemented method of claim 13, wherein the payment transaction comprises a payment from the user to a merchant.

20. The computer-implemented method of claim 19, wherein the payment transaction is initiated in response to a request from a merchant.
